(19) United States
(12) Patent Application Publication
(10) Pub. No.: US 2012/0041350 A1
(43) Pub. Date: Feb. 16, 2012

(54) MASSAGE EQUIPMENT AND AIR-BAG USED FOR THE MASSAGE EQUIPMENT

(76) Inventors: Noboru Nishiguchi, Shiga (JP); Mitsuru Tomita, Aichi (JP); Satoru Kuno, Aichi (JP)

(21) Appl. No.: 13/263,390

(22) PCT Filed: Apr. 5, 2010
(86) PCT No.: PCT/JP2010/056157

§ 371 Date: Oct. 7, 2011

(30) Foreign Application Priority Data
Apr. 9, 2009 (JP) 2009-095115

(51) Int. Cl. A61H 9/00

(52) U.S. Cl. 601/148

(57) ABSTRACT

A massage apparatus includes a main frame and an air-bag for massage. The air-bag includes an air-bag front section and an air-bag main body fixed to the dorsal side of the air-bag front section. The air-bag is arranged that the dorsal side of the air-bag main body is disposed toward the main frame so that the front side of the air-bag front section makes up a contact side with a human body. The dorsal surface of the air-bag main body is configured to be able to expand and shrink, and the air-bag front section is configured so as to remain flat even when the air-bag main body is expanded or shrunken.

### TECHNICAL FIELD

The present invention relates generally to a massage apparatus and, more particularly, to a massage apparatus including an air-bag configured to freely expand/shrink, and the air-bag used for the massage apparatus.

### BACKGROUND ART

Japan patent application laid-open No. 2004-208880A published on Jul. 29, 2004 discloses a massage apparatus. This massage apparatus has a base body, a frame to which the base body is fixed, and so on, and a concave portion for fitting in a human leg is formed at the base body. This concave portion is formed in a grooved-shape from the top edge to the bottom edge of the base body, and side walls of the concave portion are provided with bag-shaped air-bags. This massage apparatus can provide massage to a user's leg which is put in the concave portion by supplying and exhausting air to expand and shrink the air-bag.

When air is filled inside the above air-bag, the whole surface of the air-bag expands. Thus, in order to provide a cover for covering the air-bag, it is necessary that the cover is made from a stretchable cloth or from a cloth with a looseness considering the expansion of the air-bag surface. Therefore, the cover can not be made from a hardly deformed material, such as leather which can give a sense of quality. Therefore, the aesthetic characteristic has been limited.

### DISCLOSURE OF THE INVENTION

It is an object of the present invention to provide massage apparatus which allows freely selecting the materials of the cover of the air-bag.

A massage apparatus (1) of the present invention comprises a main frame (10) and an air-bag (70) for massage attached to the main frame (10). The air-bag (70) comprises an air-bag front section (71) and an air-bag main body (72) fixed to the dorsal side of the air-bag front section (71). The air-bag (70) is arranged that the dorsal side of the air-bag main body (72) is disposed toward the main frame (10) so that the front side of the air-bag front section (71) makes up a contact side with a human body. A dorsal surface of the air-bag main body (72) is configured to be able to expand and shrink, and the airbag front section (71) is configured so as to remain flat even when the air-bag main body (72) is expanded or shrunken.

In one embodiment, the main frame (10) comprises a base (11) having a recess (5) for accommodating a human leg and a movable member (12) to which the air-bag (70) is attached. The movable member (12) is supported by the base (11) so as to be able to switch its position between a closed state in which the movable member (12) covers to close an opening of the recess (5) of the base (11) in order that the air-bag front section (71) of the air-bag (70) attached to the movable member (12) forms a substantially-flat footrest surface and an opened state in which the air-bag front section (71) locates lateral to the human leg.

In one embodiment, the air-bag (70) comprises a nozzle (73) for air supply and exhaust projecting from peripheral part of the air-bag main body (72) and a flange (74) extending from circumference of the air-bag front section (71). A part of the flange (74) extends along the nozzle (73).

In another embodiment, the air-bag (70) comprises a first air-bag (701) and a second air-bag (702). The first air-bag (701) comprises a nozzle (731) for air supply and exhaust projecting from peripheral part of the air-bag main body (721). The second air-bag (702) comprises a flange (742) extending from circumference of the air-bag front section (712). A part of the flange (742) of the second air-bag (702) extends along the nozzle (731) of the first air-bag (701).

In a preferred embodiment, the dorsal surface of the air-bag main body (72) comprises a plurality of peak parts (75) configured to be distant from the air-bag front section (71) when the air-bag (70) is shrunken and a plurality of valley parts (76) configured to be close to the air-bag front section (71) when the air-bag (70) is shrunken, said peak parts (75) and said valley parts (76) being arranged alternately. The air-bag (70) is configured so that bottoms of the valley parts (76) in the dorsal surface of the air-bag main body (72) are in contact with the air-bag front section (71) side when the air-bag (70) is shrunken.

In one embodiment, the front side of the air-hag front section (71) of the air-bag (70) is covered by an exterior member (8) having non-stretch properties. The exterior member (8) is fastened to the air-bag (70) at the air-bag front section (71) or at periphery of the air-bag front section (71).

In this case, the air-bag front section (71) may comprises a flange (74) extending from the circumference thereof, and the exterior member (8) may be fastened to the flange (74) directly or through a reinforcing member (79).

In one embodiment, the air-bag main body (72) is fixed to the air-bag front section (71), thereby an enclosed space is formed inside the air-bag (70).

In another embodiment, the air-bag main body (72) is formed in a bag-shape having an enclosed space therein, and the air-bag (70) is constructed by fixing the air-bag main body (72) to the air-bag front section (71).

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is a perspective view of a massage apparatus according to one embodiment of the present invention,

FIG. 2 is a figure showing the massage apparatus according to one embodiment of the present invention, and is a perspective view showing a state in which an open-close plate is opened,

FIG. 3 is a figure showing the massage apparatus according to one embodiment of the present invention, and is a perspective view showing a state in which the open-close plate is closed,

FIG. 4 is a perspective view showing a massage chair to which the massage apparatus according to one embodiment of the present invention is connected,

FIG. 5 is a figure showing an air-bag assembly used in the massage apparatus according to one embodiment of the present invention, FIG. 5A is an exploded perspective view, and FIG. 5B is a sectional view,

FIG. 6 is a perspective view of an air-bag used in the massage apparatus according to one embodiment of the present invention seeing from the dorsal side,

FIG. 7 is a figure showing a pair of air-bags used in the massage apparatus according to one embodiment of the present invention, FIG. 7A is a perspective view seeing from the front side, and FIG. 7B is perspective view seeing from the dorsal side,

FIG. 8 is a perspective view of another air-bag used in the massage apparatus according to one embodiment of the present invention, and

FIG. 9A is a sectional view of the air-bag used in the massage apparatus according to one embodiment of the present invention, and FIG. 9B is a sectional view of a conventional air-bag.

### BEST MODE FOR CARRYING OUT THE INVENTION

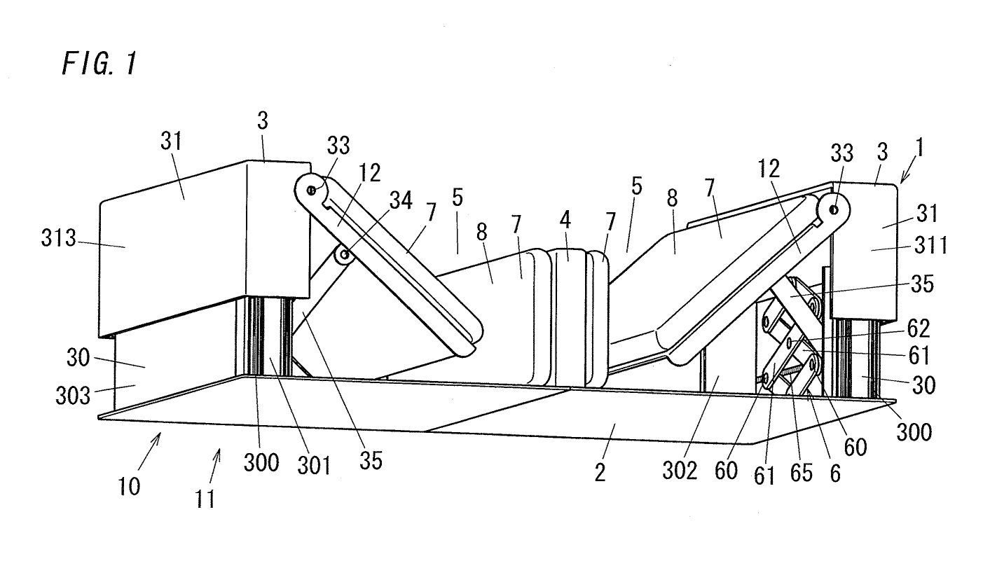

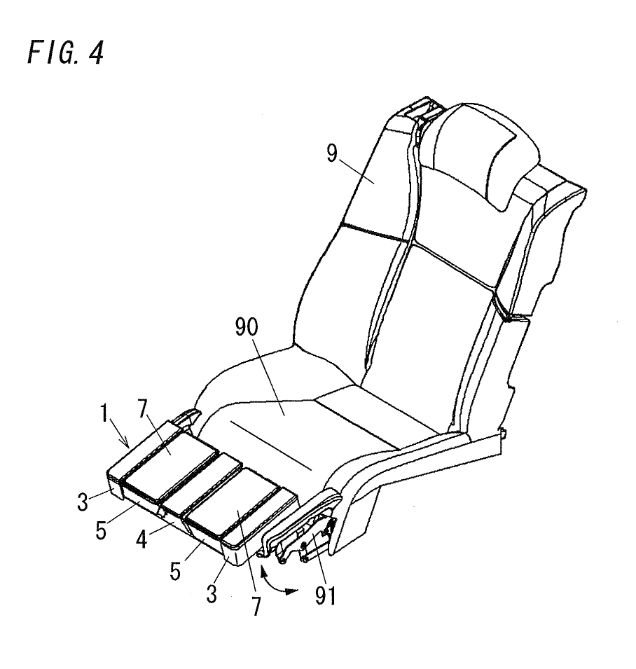

FIGS. 1 to 3 show a massage apparatus for legs 1 according to one embodiment of the present invention. This massage apparatus for legs 1 includes a main frame 10 and air-bag assemblies 7. For example, the massage apparatus 1 is attached to the front side of a seat 90 of a massage chair 9 via a link mechanism 91, as shown in FIG. 4. The massage apparatus 1 is configured so that it can turn, by the link mechanism 91, between a state in which it is located on approximately the same plane with the seat 90 as shown in FIG. 4 and a state in which it droops from the front end of the seat 90.

The main frame 10 includes a base 11 and a pair of open-close plates 12, 12, wherein said open-close plate 12 is a movable member. The base 11 includes a rectangular-shaped basal plate 2, a pair of elevating mechanisms 3, 3, and a center wall 4. The basal plate 2 is formed widely from front to back and from right to left, and is arranged so that it is elongated in the right-left direction. The pair of elevating mechanisms 3, 3 is located on the top surface of the basal plate 2. The center wall 4 is located on the top surface of the basal plate 2. The air-bag assembly 7 is configured for massage. As shown in FIG. 1, the air-bag assemblies 7 are located on surfaces of the open-close plates 12, 12, and the right and the left side surfaces of the center wall 4, respectively. The air-bag assembly 7 is configured to expand and shrink by air supply or air exhaust by use of an air-pump (not shown in figure) and a supply-exhaust valve (not shown in figure).

The central wall 4 is formed in a rectangular-shape elongated in the front-back direction, and projects upwardly from the middle of the basal plate 2. Each one of the paired elevating mechanisms 3, 3 is formed in a rectangular-shape elongated in the front-back direction. The paired elevating mechanisms 3, 3 project upwardly from both the right and the left end of the top surface of the basal plate 2, and face to the right and the left side of the center wall 4. Between the pair of elevating mechanisms 3, 3 and the central wall 4, a pair of recess 5, 5 arranged in almost parallel is formed in the front-back direction. Human's leg can be placed in each one of the paired recesses 5, 5.

The elevating mechanism 3 includes an inner base 30 fixed to the basal plate 2 and an outside cover 31 surrounding the inner base 30 from the outside. The inner base 30 has a rectangular front plate 301, a rectangular rear plate 302, and a rectangular side plate 303 connecting the front plate 301 and the rear plate 302. Rails 300 extending in the vertical direction are formed on the outer surface (front surface) of the front plate 301 and the outer surface (rear surface) of the rear plate 302. The outside cover 31 is composed of a rectangular front cover plate 311 covering the front surface of the inner base 30, a rectangular rear cover plate 312 covering the rear surface of the inner base 30, a rectangular side cover plate 313 covering the outside surface of the side plate 303 of the inner base 30, and a top cover plate 314 covering the top surface of the inner base 30. Rails 310 which can be coupled with the rails 300 of the inner base 30 are formed on the inside surface (rear surface) of the front cover plate 311 and the inside surface (front surface) of the rear cover plate 312. The outside cover 31 is configured to be slidable in the vertical direction with respect to the inner base 30 by virtue of the rails 300, 310.

A telescopic mechanism 6 for connecting the basal plate 2 and the outside cover 31 is arranged inside the inner base 30. The telescopic mechanism 6 is configured so that it can elongate and contract in the vertical direction, and the upper end part thereof is connected to the lower surface of the top cover plate 314 of the outer cover 31 and the lower end part thereof is connected to the top surface of the basal plate 2.

The telescopic mechanism 6 has a plurality of paired plates, said paired plates being composed of a pair of rectangular flat plates 61. This pair of flat plates 61 is pivotally connected by a shaft 62 at each longitudinal centers, and come to an X-shaped. Each ends of the flat plates 61 of the paired plates is pivotally connected to an end of a flat plate 61 of another paired plate by a shaft part 60. Also, a threaded shaft 65 having a positive thread part and a reverse thread part is arranged at the shaft parts 60, 60 of the telescopic mechanism 6. A pair of screw nuts (not shown in figure), each of which screws to engage with the positive thread part or the reverse thread part of the threaded shaft 65, is comprised at the paired shaft parts 60, 60.

When the threaded shaft 65 is rotated by a motor (not shown in figure), the paired screw nuts attached to the shaft parts 60, 60 move in the opposite direction to each other along the threaded shaft 65 elongated in the front-back direction. Thereby, distance between the shaft parts 60, 60 changes, and the telescopic mechanism 6 is elongated or contracted in the vertical direction. When the telescopic mechanism 6 is elongated or contracted, the outside cover 31 slides in the vertical direction with respect to the inner base 30. As a result, the elevating mechanism 3 elongates or contracts, and thereby the height from the basal plate 2 of the elevating mechanism 3 changes. When the elevating mechanism 3 is shortened, the height from the basal plate 2 of the elevating mechanism 3 becomes about the same with the height from the basal plate 2 of the central wall 4. The height from the basal plate 2 of the elevating mechanism 3 becomes higher than the height from basal plate 2 of the center wall 4 when the elevating mechanism 3 is extended. Note that, the telescopic mechanism 6 may be configured to connect between the inner base 30 and the outside cover 31.

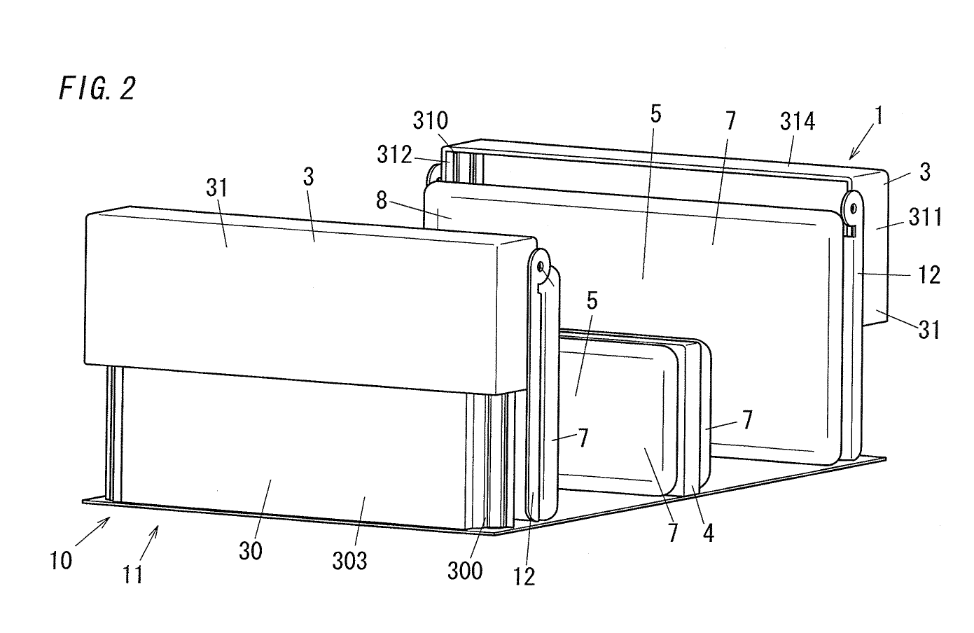

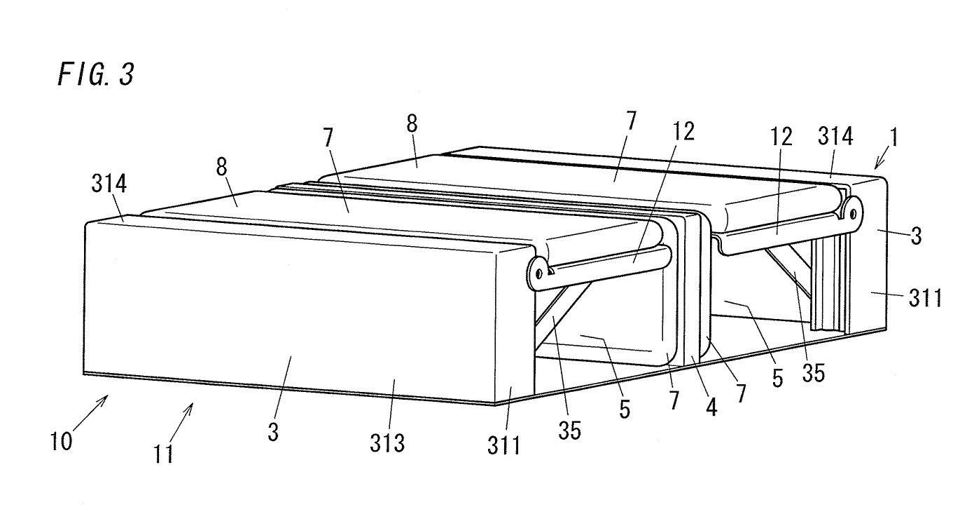

The pair of rectangular open-close plates 12, 12 is attached to the center wall 4 sides of the pair of outside covers 31, 31. The top edges of the front and the rear side of the open-close plate 12 are connected by shafts 33 to the top edge of the front cover plate 311 and the top edge of the rear cover plate 312 of the outside cover 31, respectively. The open-close plate 12 is configured to turn around the shaft 33 in a clockwise or counterclockwise direction seeing from the front. Longitudinal one ends of flat board-shaped links 35 are connected to the front and the rear side of the open-close plate 12 by shafts 34, respectively. The link 35 is configured to turn around the shaft 34 with respect to the open-close plate 12. Longitudinal the other end of the link 35 is pivotally connected to the front plate 301 or the rear plate 302 of the inner base 30 by a shaft (not shown in figure). By virtue of the presence of the links 35, the open-close plate 12 turns in a clockwise or counterclockwise direction seeing from the front accompanying with the extension/contraction of the elevating mechanism 3. When the elevating mechanism 3 is elongated and the height from the basal plate 2 becomes higher, the open-close plate 12 becomes along the surface of the elevating mechanism 3 of the center wall 4 side, as shown in FIG. 2. When the elevating mechanism 3 is contracted, the open-close plate 12 covers the opening of the recess 5, as shown in FIG. 3. In other words, the recess 5 is left open when the height of the elevating mechanism 3 is raised, and the recess 5 is closed by the open-close plate 12 when the height of the elevating mechanism 3 is lowered.

According to the above-mentioned massage apparatus 1, if a human's leg is placed in the recess 5 when the elevating mechanism 3 is extended thereby the opening of the recess 5 is opened (opened state; refer to FIG. 2), the air-bag assemblies 7 are positioned adjacent to the leg. If the air-bag assembly 7 is expanded and shrunken in this state, the air-bag assembly 7 presses and releases the leg in the recess 5 to provide massage.

On the other hand, when the elevating mechanism 3 is contracted, the open-close plate 12 closes up the recess 5. This time, a surface of the open-close plate 12 on which the air-bag assembly 7 is arranged forms an approximately flat footrest surface at the front side of the massage apparatus 1 (closed state; refer to FIG. 3). Thereby, the massage apparatus 1 serves as a footrest board. In this state, a human can put one's leg on the surface of the massage apparatus 1 without being regulated by the recess 5, and a relaxed state can be obtained. At this state, also, because the elevating mechanism 3 is contracted and the height from the basal plate 2 is lowered, the height of the massage apparatus 1 can be reduced. Therefore, the elevating mechanism 3 does not interfere when sitting down on the massage chair 9 or standing up from the massage chair 9 (refer to FIG. 4).

Next, the air-bag assembly 7 is described.

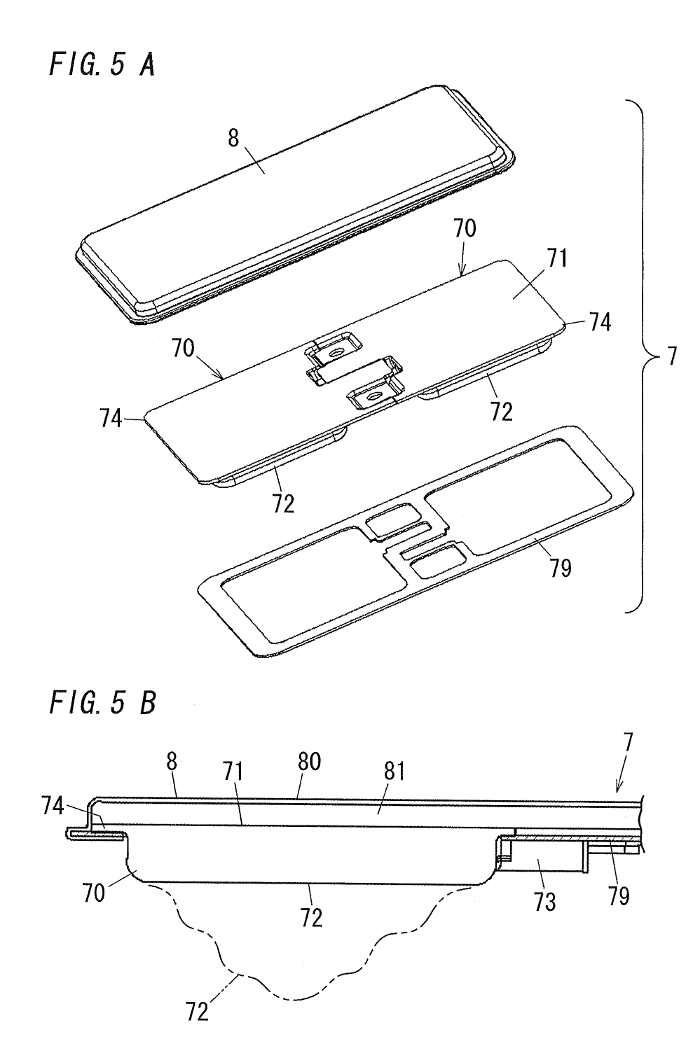

As shown in FIG. 5A, the air-bag assembly 7 is composed of a pair of air-bags 70, 70, a reinforcing plate 79, and an exterior member 8. The paired air-bags 70, 70 are formed in the same shape and the same size.

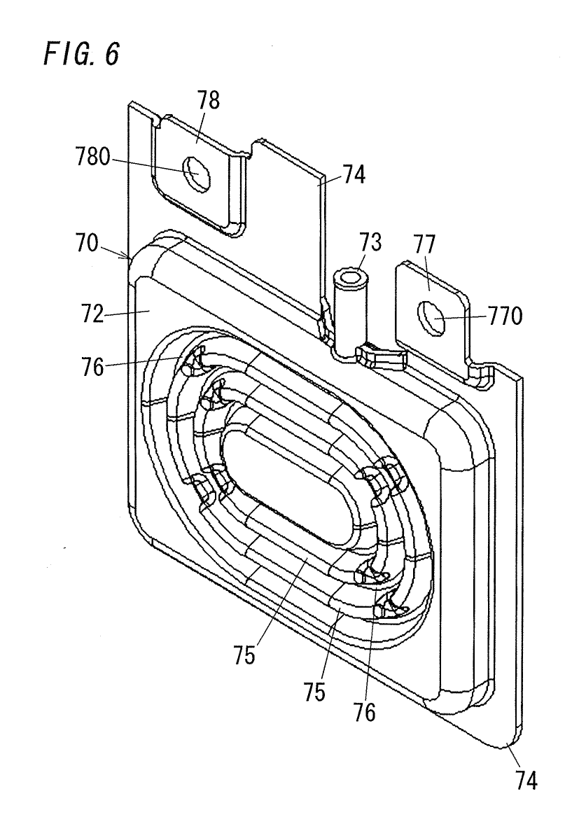

The air-bag 70 is a hollow body, and as shown in FIG. 6, it includes a flat board-shaped air-bag front section 71 constructed of synthetic resin and a rectangular air-bag main body 72 constructed of synthetic resin. The front side of the air-bag front section 71 is formed in approximately flat planar-shape. The air-bag main body 72 is fixed to the dorsal side of the air-bag front section 71. In the present configuration, the air-bag main body 72 is not a bag-shaped, but an enclosed space is formed inside the air-bag 70 by fixing the air-bag main body 72 to the air-bag front section 71. Note that, it may use a bag-shaped air-bag main body 72 having an enclosed space therein. In such a configuration, this air-bag main body 72 may be fixed to the air-bag front section 71.

A nozzle 73 for supply/exhaust of air protrudes from peripheral part of the air-bag main body 72. Besides, a flange 74 integrally extends from circumference of the air-bag front section 71 toward outside.

As shown in FIG. 6, a plurality of peak parts 75 and a plurality of valley parts 76 are formed at the dorsal surface of the air-bag main body 72, wherein the plurality of peak parts 75 are configured to be distant from the air-bag front section 71 at the contraction of the air-bag 70, and wherein the plurality of the valley parts 76 are configured to be close to the air-bag front section 71 at the contraction of the air-bag 70. The peak parts 75 and the valley parts 76 are alternately formed in a concentric pattern. When pressurized air is filled inside the air-bag 70 via the nozzle 73, the air-bag 70 expands in a manner that the central part of the dorsal surface of the air-bag main body 72 largely protrudes, as shown in a two-dotted chain line in FIG. 5B. On the other hand, even when air is filled in the air-bag 70, the air-bag front section 71 hardly expands and maintains an approximately flat state.

As shown in FIG. 6, the flange 74 is provided with a connecting part 77 having a connection hole 770 and a connected part 78 having a connection hole 780. The connecting part 77 and the connected part 78 are extended in the same direction with the projecting direction of the nozzle 73. A pair of airbags 70, 70 is united by superimposing a connecting part 77 of one air-bag 70 on a connected part 78 of the other air-bag 70, and passing a bolt through the connection hole 770 and the connection hole 780 to fix them. In the united pair of air-bags 70, 70, the surface of the front side of the pair of air-bags 70, 70 is approximately rectangle-shaped as shown in FIG. 5A.

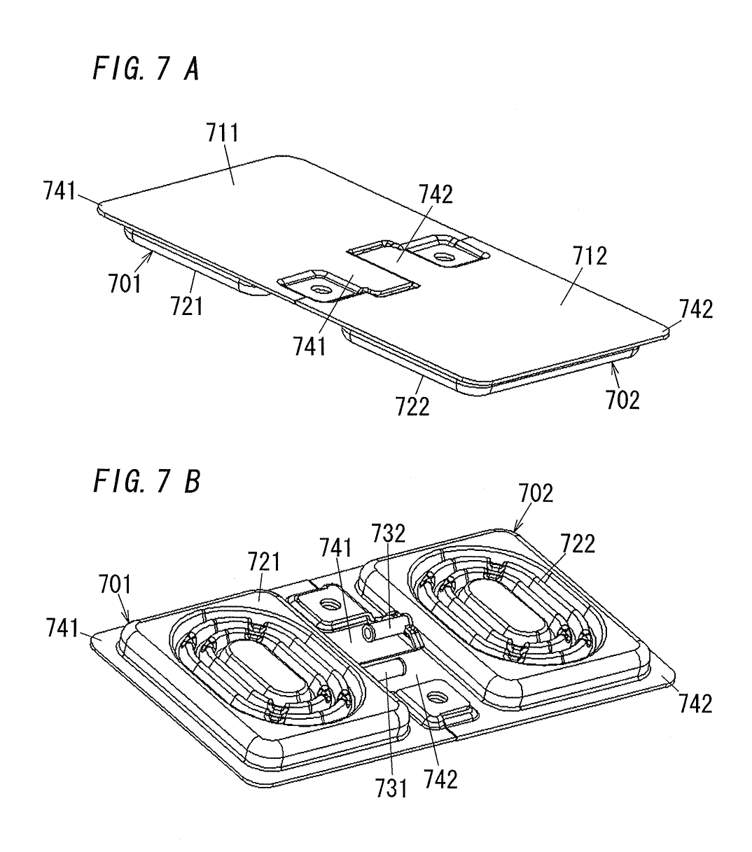

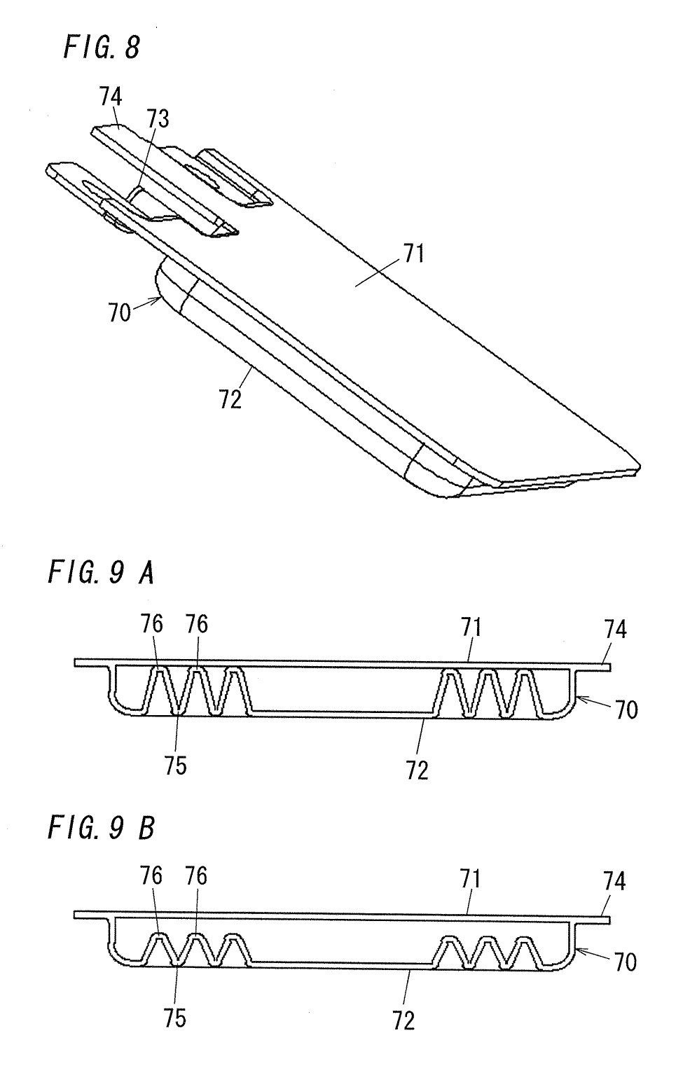

As mentioned above, the air-bag assembly 7 has two air-bags 70 formed in the same shape and the same size. In the following, these two air-bags are referred to as a first air-bag 701 and a second air-bag 702 as shown in FIG. 7A, FIG. 7B. As shown in FIG. 7B, a part of flange 741 extending from an air-bag front section 711 of the first air-bag 701 towards the second air-bag 702 is configure to extend along a nozzle 732 projecting from an air-bag main body 722 of the second air-bag 702, and covers the nozzle 732 from the front side of the second air-bag 702. Also, a part of flange 742 extending from an air-bag front section 712 of the second air-bag 702 towards the first air-bag 701 is configured to extend along a nozzle 731 projecting from an air-bag main body 721 of the first air-bag 701, and covers the nozzle 731 from the front side of the first air-bag 701. Thereby, irregularity by the nozzles 731, 732 does not appear in the air-bag front section 711, 712 side. By virtue of such a configuration, it can prevent the appearance of irregularity by the nozzles 731, 732 at the front side of the air-bags 701, 702 while the airbags 701, 702 can be produced easily. Note that, as shown in FIG. 8, it may be configured that a part of the flange 74 of the air-bag 70 extends along its own nozzle 73 and the flange 74 covers the nozzle 73 from the front side of the air-bag 70.

As shown in FIG. 5A, the reinforcing plate (reinforcing member) 79 covers the flanges 74, 74 of the pair of air-bags 70, 70 from the dorsal side. By virtue of the reinforcing plate 79, deformation of the air-bags 70, 70 can be prevented.

As shown in FIG. 5B, the exterior member 8 includes a non-stretchable cover portion 80 and a pad 81 having elasticity. The cover portion 80 covers up the air-bag front sections 71, 71 and the flanges 74, 74 from the front side of the pair of air-bags 70, 70. The pad 81 is provided along the circumference of the cover portion 80. As shown in FIG. 5B, the pad 81 is fastened to the reinforcing plate 79 in a manner of tucking the circumferential part of the reinforcing plate 79.

As for the above air-bag assembly 7, the dorsal side of the air-bag main body 72 is located at the main frame 10 side so that the front side of the air-bag front section 71 becomes a contact side with a human body. That is, in a state in which the open-close plate 12 is opened as shown in FIG. 2, the exterior member 8 of the air-bag assembly 7 comes in contact with a human leg to provide massage. On the other hand, in a state in which the open-close plate 12 is closed as shown in FIG. 3, the exterior member 8 of the air-bag assembly 7 forms an approximately flat footrest surface.

By the way, in case that the cover portion 80 of the exterior member 8 is thin, there is a possibility that the human leg put on the footrest surface feels irregularity of the air-bag 70. In the present configuration, however, irregularity by the peak parts 75 and the valley parts 76 which must be provided in order for making the air-bag 70 freely expand/shrink and irregularity by the nozzle 73 are covered over by the air-bag front section 71 and the flange 74. Therefore, these irregularities do not appear at the front side of the air-bag 70. That is, even if in this case, the possibilities that a human's leg put on the air-bag assembly 7 feels the above irregularity is made small.

Herein, the air-bag front section 71 is not a complete rigid body. Therefore, there is a possibility that a deflection occurs at the air-bag front section 71 when filling air or receiving the weight of a human leg. The deflection in case of expansion may not become a problem because it is expanded for applying a pressure to a human body. However, it is less preferred that a dent is arisen at the shrunken state because it is desired to be kept in a flat state at this time. For this purpose, in the present configuration, it is configured that bottoms of the valley parts 76 of the air-bag main body 72 contact with the air-bag front section 71 when the air-bag 70 is shrunken as shown in FIG. 9A. By virtue of such a configuration, the air-bag front section 71 is to be supported by the valley parts 76 in the dorsal surface of the air-bag main body 72. Therefore, a deflection of the air-bag front section 71 can be inhibited. Note that, according to a conventional air-bag 70, bottoms of valley parts 76 are configured to be apart from an air-bag front section 71 as shown in FIG. 9B, and the valley parts 76 do not inhibit a deflection of the air-bag front section 71.

This air-bag assembly 7 is attached to the open-close plate 12 by connecting one side edge of the air-bag main body 72 to one side edge of the open-close plate 12. Herein, the exterior member 8 is not directly connected to the open-close plate 12. Therefore, the shape of the exterior member 8 is not affected even when distance between the open-close plate 12 and the air-bag 70 changes by the expansion of the air-bag 70. Thus, materials of the cover portion 80 of the exterior member 8 can be selected freely. In the present configuration, the cover portion 80 is made from leather which has non-elasticity and can provide a sense of quality. Also, a cover (not shown in figure) made of an elastic cloth or a cloth having a looseness is arranged between the flange 74 and a side of the open-close plate 12. When the air-bag 70 expands, a gap occurs between the open-close plate 12 and the flange 74. However, this gap is covered over by the above-mentioned cover. Herein, configuration of the installation of the air-bag assembly 7 to the central wall 4 is similar with the installation to the open-close plate 12, too.

Note that, the configuration of the main frame 10 is not limited to the above configuration. For example, the elevating mechanism 3 may be configured not to extend and contract. Besides, the elevating mechanism 3 may be configured not to include the open-close plate 12 thereby configured that the recess 5 always appears. Also, the massage apparatus 1 is not limited to a thing for legs.

Although the present invention has been described with reference to certain preferred embodiments, numerous modifications and variations can be made by those skilled in the art without departing from the true spirit and scope of this invention, namely claims.

1. A massage apparatus comprising:
a main frame; and
an air-bag for massage attached to the main frame,
wherein the air-bag comprises: an air-bag front section; and an air-bag main body fixed to the dorsal side of the air-bag front section,
wherein the air-bag is arranged that the dorsal side of the air-bag main body is disposed toward the main frame so that the front side of the air-bag front section makes up a contact side with a human body, and
wherein a dorsal surface of the air-bag main body is configured to be able to expand and shrink, and the air-bag front section is configured so as to remain flat even when the air-bag main body is expanded or shrunken.

2. A massage apparatus as set forth in claim 1,
wherein the main frame comprises: a base having a recess for accommodating a human leg; and a movable member to which the air-bag is attached, and
wherein the movable member is supported by the base so as to be able to switch its position between a closed state in which the movable member covers to close an opening of the recess of the base in order that the air-bag front section of the air-bag attached to the movable member forms a substantially-flat footrest surface and an opened state in which the air-bag front section locates lateral to the human leg.

3. A massage apparatus as set forth in claim 1,
wherein the air-bag comprises: a nozzle for air supply and exhaust projecting from peripheral part of the air-bag main body; and a flange extending from circumference of the air-bag front section, and
wherein a part of the flange extends along the nozzle.

4. A massage apparatus as set forth in claim 1,
wherein the air-bag comprises: a first air-bag; and a second air-bag,
wherein the first air-bag comprises a nozzle for air supply and exhaust projecting from peripheral part of the air-bag main body,
wherein the second air-bag comprises a flange extending from circumference of the air-bag front section, and
wherein a part of the flange of the second air-bag extends along the nozzle of the first air-bag.

5. A massage apparatus as set forth in claim 1,
wherein the dorsal surface of the air-bag main body comprises: a plurality of peak parts configured to be distant from the air-bag front section when the air-bag is shrunken; and a plurality of valley parts configured to be close to the air-bag front section when the air-bag is shrunken, said peak parts and said valley parts being arranged alternately, and
wherein the air-bag is configured so that bottoms of the valley parts in the dorsal surface of the air-bag main body are in contact with the air-bag front section side when the air-bag is shrunken.

6. A massage apparatus as set forth in claim 1,
wherein the front side of the air-bag front section of the air-bag is covered by an exterior member having non-stretch properties, and
wherein the exterior member is fastened to the air-bag at the air-bag front section or at periphery of the air-bag front section.

7. A massage apparatus as set forth in claim 6,
wherein the air-bag front section comprises a flange extending from the circumference thereof, and
wherein the exterior member is fastened to the flange directly or through a reinforcing member.

8. A massage apparatus as set forth in claim 1, wherein the air-bag main body is fixed to the air-bag front section, thereby an enclosed space is formed inside the air-bag.

9. A massage apparatus as set forth in claim 1,
wherein the air-bag main body is formed in a bag-shape having an enclosed space therein, and
wherein the air-bag is constructed by fixing the air-bag main body to the air-bag front section.

10. An air-bag used for the massage apparatus as set forth in claim 1.

11. An air-bag used for the massage apparatus as set forth in claim 2.

12. An air-bag used for the massage apparatus as set forth in claim 3.

13. An air-bag used for the massage apparatus as set forth in claim 4.

14. An air-bag used for the massage apparatus as set forth in claim 5.

15. An air-bag used for the massage apparatus as set forth in claim 6.

16. An air-bag used for the massage apparatus as set forth in claim 7.

17. An air-bag used for the massage apparatus as set forth in claim 8.

18. An air-bag used for the massage apparatus as set forth in claim 9.
